(19) United States
(12) Patent Application Publication
(10) Pub. No.: US 2020/0197860 A1
(43) Pub. Date: Jun. 25, 2020

(54) A Method for Separating Fluidic Water from Impure Fluids and a Filter therefore

(71) Applicant: CNM Technologies GmbH, Bielefeld (DE)

(72) Inventors: Wulf Siegfried Luck, Berlin (DE); Xianghui Zhang, Bielefeld (DE); Yang Yang, Bielefeld (DE); Armin Gölzhäuser, Bielefeld (DE); Albert Schnieders, Bielefeld (DE)

(21) Appl. No.: 16/612,504

(22) PCT Filed: May 28, 2018
(86) PCT No.: PCT/EP2018/063163

§ 371 Date: Nov. 11, 2019

(30) Foreign Application Priority Data
May 18, 2017 (LU) 100251
Nov. 23, 2017 (GB) 1719475.4

(51) Int. Cl. B01D 53/22; B01D 69/02; B01D 67/00; B01D 71/02

(52) U.S. Cl. CPC B01D 53/228; B01D 69/02; B01D 67/0006; B01D 2325/02; B01D 2323/34; B01D 2323/30; B01D 2325/04; B01D 71/021

(57) ABSTRACT

A method of separating fluidic water from impure fluids is disclosed. The impure fluids comprising fluidic water and one or more substances having a kinetic diameter similar to that of water molecules. The kinetic diameter of the one or more substances is at most 50% and preferably 33% greater than that of the water molecules. The method comprises applying to a first side of a carbon nanomembrane the impure fluid; and collecting from the opposite of the carbon nanomembrane the fluidic water. The method can be used in filter applications.

### CROSS REFERENCE TO CO-PENDING APPLICATIONS

This application is a national phase entry of PCT Patent Application No. PCT/EP2018/063163 filed on 18 May 2018 claiming priority of Luxembourg Patent Application No. LU100251 filed on 18 May 2017 and UK Patent Application No. GB1719475.4 filed on 23 Nov. 2017 all of which are entitled “A Method for Separating Fluidic Water from Impure Fluids and a Filter therefore” and the content of which is incorporated herein by reference.

### REFERENCE TO GOVERNMENT SPONSORED RESEARCH

This invention was made with German Federal government support under the program “Werkstoffinnovationen für Industrie und Gesellschaft” with the project title MOLFIL-CNM “Gasfiltration durch maBgeschneiderte Molekularfilter aus Carbon Nanomembranes (CNMs) und Graphen” (“Gas separation by tailored molecular filters made from Carbon Nanomembranes (CNMs) and Graphene”) awarded to the Universitat Bielefeld by the German Federal Ministry of Education and Research. Grant Number 03X0158A.

### BACKGROUND OF THE INVENTION

### Field of the Invention

The invention relates to a method and a filter for separating fluidic water from impure fluids.

### Brief Description of the Related Art

There has been recent activity in the field of fluid separation by use of carbon-based monolayer membranes. For example, U.S. Pat. No. 9,358,508 B2 teaches a separation of water from a gas or liquid by use of a graphene oxide membrane or a perforated graphene monolayer. Such perforated graphene monolayers are marketed under the trade name Perforene. The use of a graphene oxide membrane for the separation of water is also known from US 2015/0231577. The transport of water through the graphene oxide membrane in these documents is due to transport between the flakes of the material. The flakes start to swell on contact with water, which means that the distance between the flakes changes (increases) and thus selectivity against particles with a similar kinetic diameter is lost.

Breathable membranes comprising a plurality of carbon nanotubes are known from the publication of N. Bui et al., “Ultra breathable and Protective Membranes with Sub-5 nm Carbon Nanotube Pores”, Adv. Mater. 28, 5871-5877 (2016). The carbon nanotubes are known to have very high water transportation rates, see G. Hummer et al., “Water conduction through the hydrophobic channel of a carbon nanotube”, Nature 414, 188-190 (2001); A. McGaughey et al., “Materials enabling nanofluidic flow enhancement”, MRS Bulletin 42, 273-275 (2017); and M. Majumder et al., “Flows in one-dimensional and two-dimensional carbon nanochannels: Fast and curious”, MRS Bulletin 42, 278-282 (2017). However, the manufacture of such membranes with the carbon nanotubes is still expensive and technically complicated to reproduce.

The use of carbon nanomembranes for filtration of gases and liquids has already been disclosed, see for example in German Patent Application No. DE 10 2009 034575 or U.S. Pat. No. 9,186,630 B1. These patent documents disclose that the carbon nanomembrane can be used for the purification of drinking water or wastewater but fail to teach the unexpectedly high permeance for water combined with the unexpectedly high selectivity of the carbon nanomembrane for water against particles with a similar kinetic diameter. The carbon nanomembranes disclosed in this document have pores or are absorbable membranes.

The carbon nanomembranes disclosed in these patent documents are two-dimensional (2D) carbon-based materials produced from radiation-induced crosslinking of a layer of precursor molecules with an aromatic molecular backbone. CNMs based on self-assembled monolayers (SAMs) are disclosed in U.S. Pat. No. 6,764,758 B1 and by Turchanin and Gölzhäuser (“Carbon Nanomembranes”, Adv. Mater. 28, 6075-6103 (2016)). The carbon nanomembranes formed are mechanically and thermally stable. The terms “carbon nanomembrane” and “cross-linked molecular layers” can be used synonymously. Such carbon nanomembranes have been shown to act as molecular sieves and separate fluids by ballistic transport, see A. Turchanin and A. Gölzhäuser, “Carbon Nanomembranes”, Adv. Mater. 28, 6075-6103 (2016), especially page 6099. Nothing in these documents shows, however, the unexpectedly high permeance for water combined with the unexpectedly high selectivity of the carbon nanomembrane for water against particles with a similar kinetic diameter.

Methods of manufacturing such carbon nanomembranes directed at inexpensive technologies with a potential for mass production have been developed. For example, international Patent Application No WO2017/072272 teaches the manufacture of the carbon nanomembrane on cheap aluminum coated polymer foils.

The need to provide clean, potable water is one of the greatest challenges in the world. Water is abundant on the planet, but the water in liquid form is in many cases not drinkable because of contamination with impurities. In many cases only foul (impure) water is available. Traditional filtration techniques to purify water use filters with pores having a pore size that is smaller than the particles that need to be filtered out of the water. This is suitable for cleaning water in which the impurities are of a greater kinetic size than the water molecules. On the other hand, the removal of impurities with a similar kinetic size is difficult and requires techniques such as reverse osmosis.

### SUMMARY OF THE INVENTION

A method of separating fluidic water from impure fluids using a carbon nanomembrane is disclosed in this document. The impure fluids comprise fluidic water and one or more substances having a kinetic diameter similar to that of water molecules. The term “similar” in this context means that the kinetic diameter is around 50% greater—in one aspect the kinetic diameter is 33% greater—than that of the water molecules. The separation is carried out by applying to a first side of the carbon nanomembrane the impure fluid and collecting from the opposite of the carbon nanomembrane the fluidic water. It was found by the present inventors that the carbon nanomembrane has a permeance for fluidic water that is several orders of magnitude higher than that of fluids, with a similar size, like helium, neon, carbon dioxide, argon, oxygen, nitrogen, acetonitrile, n-hexane, ethanol, and 2-propanol, and can therefore be used in this application. The carbon nanomembrane. is different than a layer of graphene oxide or graphene known in the art.

The term “fluidic water” is intended to encompass both water vapor, i.e. water in a gaseous phase and liquid water. The term “kinetic diameter” is defined as the sphere of influence of the molecule that can lead to a scattering event. The kinetic diameter is greater than the diameter of the molecule, which is defined in terms of the size of the electron shell of the atoms making up the molecule.

This is a surprising effect, as the membranes known in the art acted like molecular sieves in which particles of similar kinetic size could pass through the membrane. There was no reason for the skilled person knowing the art to expect that the carbon nanomembrane disclosed in this document would have an unexpectedly high permanence for fluidic water that is substantially higher than that of the other substances in the impure water.

The carbon nanomembrane used in this method comprise laterally cross-linked aromatic compounds and, in one non-limiting example, the aromatic compounds are selected from the group consisting of polyphenyl compounds. The aromatic compounds can be terphenyl or quaterphenyl compounds, but this is not limiting of the invention.

The carbon nanomembrane has a thickness of between 0.5 nm and 100 nm. It is thought that the carbon nanomembrane have pores with diameters in the range of 0.3 nm to 1.5 nm.

The method described can be used in a filter for separating fluidic water from impure fluids.

Such applications for filters require not only a high selectivity against the substances that are separated but a high permeance of the filter for water in order to achieve a good filtering efficiency of the filter.

### DESCRIPTION OF THE FIGURES

FIG. 1 shows an example of the filter using the carbon nanomembrane described in this document.

FIG. 2 shows the experimental set up for measuring the water permeance of the carbon nanomembrane.

FIG. 3 shows the water permeance of TPT CNMs as a function of the relative humidity in the feed chamber measured in a vacuum apparatus. The permeance was detected by a quadrupole mass-spectrometer (QMS). The hollow square is the value measured by the mass loss method (example 1).

FIG. 4 shows a comparison of the measured water permeance to the permeance for helium.

FIG. 5 displays water vapor transmission rate of the carbon nanomembrane in comparison to conventional membranes.

FIGS. 6A-6E show the morphology of TPT SAM and CNM. FIG. 6A is an STM image of TPT SAM measured at room temperature in ultra-high vacuum (UHV) (U_{Bias}=500 mV, I_{T}=70 pA). FIG. 6B is an AFM image of TPT CNM measured at 93 K in UHV via AFM tapping mode of operation (amplitude set point A=8.9 nm, center frequency f₀=274.9 kHz). FIG. 6C is shows extracted line profiles in FIG. 6A. The profiles 1-2 of TPT SAM show a center-to-center intermolecular distance of ˜0.8 nm. FIG. 6D shows extracted line profiles in FIG. 6B. The profiles 3 and 4 of TPT CNM indicate a pore diameter of ˜0.6 nm. FIG. 6E shows the estimated pore diameter distributions (0.7±0.1 nm, the error bar denotes standard deviation) extracted from AFM images. The STM and AFM images shown were drift corrected.

FIG. 7 shows a comparison of single-channel water permeation coefficients between different membranes. Molecular dynamics simulation was used to study the permeation coefficients of CNTs ((5,5)CNT (B. Corry, Journal of Physical Chemistry B 112, 1427 (2008).), (6,6)CNT (B. Corry, Journal of Physical Chemistry B 112, 1427 (2008))), and a stopped-flow apparatus was employed to characterize aquaporins (AQP1 (T. Walz et al., Journal of Biological Chemistry 269, 1583 (1994)), AqpZ (M. J. Borgnia et al., Journal of Molecular Biology 291, 1169 (1999)). The permeation coefficient of TPT CNM was calculated by dividing the measured permeance by the areal density of nanochannels estimated from the AFM images

### DETAILED DESCRIPTION OF THE INVENTION

The invention will now be described in detail. Drawings and examples are provided for better illustration of the invention. It will be understood that the embodiments and aspects of the invention described herein are only examples and do not limit the scope of protection in any way. The invention is defined by the claims and their equivalents. It will be understood that features of one aspect or embodiment of the invention can be combined with the features of a different aspect or aspects and or embodiments of the invention.

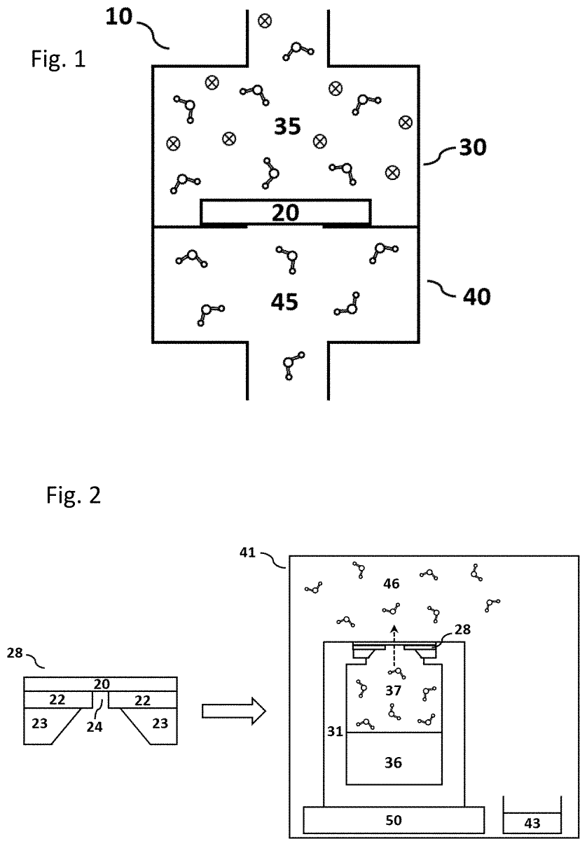

FIG. 1 shows an example of a filter 10 using a carbon nanomembrane 20 as described in this document. A first container 30 has an impure fluid 35. The impure fluid 35 comprises water with a number of other substances, for example low molecular weight materials, including but not limited to helium, neon, carbon dioxide, argon, oxygen, nitrogen, acetonitrile, n-hexane, ethanol, and 2-propanol. The impure fluid could also be sea water or other brackish water. The second container 40 on the other side of the carbon nanomembrane 20 has substantially pure water 45. The impure fluid 35 includes substances which have molecules with a similar kinetic diameter as that of water molecules and which are difficult to filter from the impure fluid 35 by prior art filter. In order to explain this surprising result, it is speculated that water transport through the carbon nanomembranes 20 could occur by a nanofluidic flow enhancement process, as will be explained below.

As noted in the introduction, the kinetic diameter is defined as the sphere of influence of the molecule that can lead to a scattering event. In the case of a water molecule the kinetic size is 265 pm. Helium and hydrogen molecules have similar kinetic diameter (260 pm and 289 pm) and thus these are particularly difficult species to remove from impure fluids. Other examples of the sizes of the kinetic diameter are generally known, for example from http://en.wikipedia.org/wiki/Kinetic_diameter (downloaded on 14 May 2018).

The carbon nanomembrane 20 used in the filter is produced by preparing a molecular thin layer of precursor compounds on a metallic or semi conductive substrate and crosslinking the molecular thin layer by electron beam or photon irradiation. The substrate may be selected from the group consisting of gold, silver, titanium, zirconium, vanadium, chromium, manganese, cobalt, tungsten, molybdenum, platinum, aluminum, iron, steel, copper, nickel, silicon, germanium, indium phosphide, gallium arsenide and oxides, nitrides or alloys or mixtures thereof, indium-tin oxide, sapphire, silicate or borate glasses, and aluminum coated polymer foils.

The carbon nanomembrane 20 is separated from the substrate and transferred to form free standing membranes or membranes supported by other surfaces or grids, see A. Turchanin, and A. Gölzhäuser, “Carbon Nanomembranes”, Adv. Mater. 28, 6075-6103 (2016); Turchanin et al., “One Nanometer Thin Carbon Nanosheets with Tunable Conductivity and Stiffness”, Adv. Mater. 21, 1233-1237 (2009), and P. Angelova et al., “A Universal Scheme to Convert Aromatic Molecular Monolayers into Functional Carbon Nanomembranes”, ACS Nano 7, 6489-6497 (2013). Alternatively, the carbon nanomembrane 20 can remain on the substrate and openings can be etched through the substrate to produce a filter 10 comprising the carbon nanomembrane 20 on a mechanically stable and permeable support.

Permeance and selectivity of the carbon nanomembrane 20 depend on a multitude of properties, such as but not limited to thickness of the carbon nanomembrane 20, diameter of pores through the carbon nanomembrane 20, density of the pores, and other properties of the material from which the carbon nanomembrane 20 is manufactured. The selection of the precursor molecules for manufacturing plays a role, since the length of the precursor molecules determines the thickness of the carbon nanomembrane 20 and/or the length of the pores through the carbon nanomembrane 20. It has been found that carbon nanomembranes 20 made from biphenyl, terphenyl and quaterphenyl compounds are suitable, but the invention is not limited thereto.

The pore diameter can be influenced by the shape of the precursor molecules e.g., “linear” precursor molecules, “condensed” precursor molecules, or “bulky” precursor molecules, see ACS Nano 7, 6489-6497 (2013). The degree of cross linking may influence the structure of the pores in the carbon nanomembrane 20. The carbon nanomembrane 20 used in the filter 10 has a degree of cross-linking of the molecules between 50%-100%, which is adjusted by varying the dose density of the radiation, and it is thought that a degree of crosslinking close to 100% is suitable. This cross-linking is for example achieved for cross-linking of biphenythiol layers on a gold substrate using electron flood-gun in a high vacuum (<5×10⁷ mbar) employing 100 eV electrons and a dose density of 50 mC/cm².

The inventors have estimated that the carbon nanomembranes 20 should have the following properties. The carbon nanomembrane 20 substantially consists of laterally cross-linked aromatic compounds. The aromatic compounds are selected, for example, from the group consisting of polyphenyl compounds, such as but not limited to a terphenyl or quaterphenyl. The carbon nanomembrane 20 has a thickness of between 0.5 and 100 nm. It is thought that the carbon nanomembrane 20 should be between 1 nm and 5 nm, or up to 20 nm thickness to work optimally. The carbon nanomembrane 20 has pores with diameters in the range of 0.3 nm to 1.5 nm (measured with low-temperature AFM in ultrahigh vacuum).

### EXAMPLES

### Example 1

The carbon nanomembrane 20 used in the filter 10 can be manufactured as follows.

Preparation and Transfer of TPT-CNM

Cleaning of Glassware

Clean flask with piranha solution (a mixture of 95% H₂SO₄ and 30% H₂O₂ (v:v=7:3)). Rinse flask with Millipore water and let it dry in oven at 120° C.

Cleaning of Au/Mica Substrate

Cut Au/mica substrates (300 nm thermally evaporated gold on mica, Georg Albert PVD-Coatings) into small pieces and clean the surface with nitrogen. Place the substrates into UV-Ozone chamber and clean for 3 min. When finished, put the substrate into ethanol for at least 20 min and then rinse the surface of the substrate with ethanol and blow the substrate dry with nitrogen.

SAM Preparation

Connect the cleaned flask with a Schlenk line (vacuum/nitrogen manifold) and degas the flask by exchanging the content alternatively with vacuum and nitrogen (for at least three times). Fill the flask at the end with nitrogen. Put the cleaned Au/mica substrate into the flask, carry out degassing procedures a few times until the pressure reaches 10⁻² mbar. If necessary, heat the flask as well to get rid of any water vapor. Add 5-10 ml of dry dimethylformamide (DMF) to the flask (do the addition under a nitrogen atmosphere) and degas the solvent several times until no bubbles are seen. Add a very small amount of 1,1′,4′,1″-Terphenyl-4-thiol (TPT) molecules (Sigma-Aldrich) to the flask, degas the system again until no bubbles are seen. Keep the flask under nitrogen and heat the solution to 70° C. After 24 h, take the sample out, rinse the sample first with DMF and then ethanol, and blow the sample dry with nitrogen. Store the sample under argon gas.

Electron Irradiation

Crosslinking of TPT-SAMs into CNMs is achieved using an electron flood-gun in a high vacuum (<5×10⁻⁷ mbar) employing 100 eV electrons and a dose density of 50 mC/cm².

Transfer of CNMs onto Silicon Nitride Membranes/Silicon Wafers

A 4% butyl acetate/ethyl lactate solution of polymethyl methacrylate (PMMA) 50K (ALLRESIST GmbH) is spin-coated on to the CNM/Au/mica surface at 4000 rpm for 40 s, then cured on a hot plate at 90° C. for 5 min. Subsequently, a 4% butyl acetate/ethyl lactate solution of PMMA 950K (ALLRESIST GmbH) is spin-coated at 4000 rpm for 40 s, then cured on a hot plate at 90° C. for 5 min. Transfer the sample to an I₂/KI/H₂O (w:w:w=1:4:40) etching bath for 3-5 min. Detach the mica layer from the PMMA-CNM-Au structure and then transfer the PMMA-CNM-Au structure back to the 12/KI/H₂O solution for 10 min to dissolve the Au. After etching, clean the PMMA-CNM structure first with water, then with KI/H₂O (w:w=1:10) solution for 2 min, and then clean with water 3 times. Transfer the PMMA-CNM structure onto a silicon nitride membrane/silicon wafer with a single hole (membrane size: 0.1 mm×0.1 mm, membrane thickness: 500 nm, hole size: 5-50 μm, Silson Ltd), let the PMMA-CNM structure dry overnight. Dissolve PMMA with acetone. The immersion time for dissolution of the PMMA layer is 1 h.

The carbon nanomembrane is then ready.

Evaluation of Water Permeation

To evaluate the water permeation through the carbon nanomembrane 20, an upright cup method is employed, as shown schematically in FIG. 2. The carbon nanomembrane is transferred onto a silicon nitride membrane 22 supported by a Si frame 23 where the silicon nitride membrane 22 has a regular hole 24 to form a test sample 28 (as described before). Then the test sample 28 is glued onto a metal container 31 which is filled with a specified amount of water 36. The metal container 31 with the test sample 28 is then placed into an enclosed oven 41 with a constant temperature (30±0.1° C.). The water vapor 46 inside the oven is controlled to a relative humidity (RH) of 15%±2% by a saturated LiCl solution 43. The water vapor 37 above the water 36 inside the metal container 31 will reach a relative humidity of 100% since the metal container 31 contains pure water inside. Due to the differential water vapor pressure inside and outside the metal container 31 the water 37 will be transported through the carbon nanomembrane 20. The weight loss of water 36 inside the metal container 31 is measured after several days by using a balance 50. The water permeance of the carbon nanomembrane 20 can be calculated by the following equations:

$$Permeance = \frac{weigh loss rate ( \frac{Δ w}{t} )}{membrane area ( A ) \times pressuredifference ( Δ P )}$$

$$Δ P = satured vapor pressure \times ( 1 - RH )$$

TABLE 1
measured permeance for terphenyl (TPT) and for
quaterphenyl (QPT) based membranes.
They are both (1.2 ± 0.2) × 10⁻⁴ mol m⁻² s⁻¹ Pa⁻¹.

| | Water Permeance (mol m⁻² s⁻¹ Pa⁻¹) | |
|---|---|---|
| Samples | TPT-CNM | QPT-CNM |
| 1 | 1.08E−04 | 1.39E−04 |
| 2 | 8.97E−05 | 1.19E−04 |
| 3 | 1.13E−04 | 1.19E−04 |
| 4 | 1.27E−04 | |
| 5 | 1.27E−04 | |
| 6 | 1.13E−04 | |
| Average value | 1.13E−04 | 1.26E−04 |
| Standard deviation | 1.37858E−05 | 1.17453E−05 |

It was found that, for other (polar and non-polar) liquids like acetonitrile (kinetic diameter of about 0.34 nm), n-hexane (kinetic diameter of about 0.43 nm), ethanol (kinetic diameter of about 0.43 nm) and 2-propanol (kinetic diameter of 0.47 nm), no weight loss was detected, indicating that CNMs have a high selectivity of water against other liquids with small kinetic diameter.

The carbon nanomembranes described in this document are produced by crosslinking with electron beam or photon irradiation. Subsequent irradiation therefore does not significantly change their properties. This feature makes them suitable for use in locations in which they experience significant radiation. Examples include, but are not limited to, spacecraft or power stations. The carbon nanomembranes are likely to suffer less damage from the radiation compared to other materials.

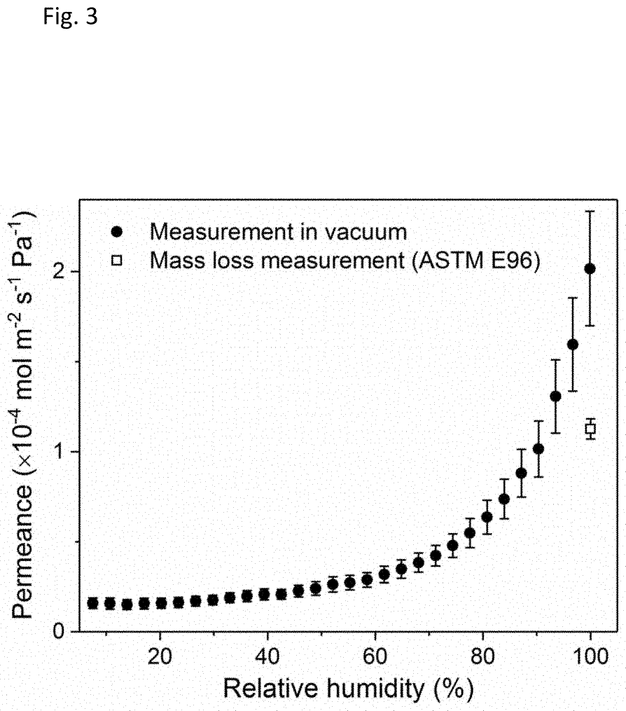

The high water permeance of CNMs was independently confirmed by vapor transport measurements in vacuum. One side of the CNMs was exposed to water vapor under controlled relative humidity (RH) and the flow of permeating molecules was detected by a quadrupole mass spectrometer placed behind the other side of the CNMs. Within the level of experimental accuracy, the water permeance at saturation conditions (100% RH) agrees well with the gravimetric results (FIG. 3). At lower levels of humidity, the permeance dropped, indicating that the higher permeance at saturation pressure was caused by water condensation. Unlike graphene oxide membranes of the prior art, the permeance of CNMs did not vanish with decreasing humidity but remained at ˜2.0×10⁵ mol·m⁻²·s⁻¹·Pa⁻¹ at RH below 20%. This is likely related to a transition between different transport mechanisms. Interestingly, the permeance of helium (˜4.5×10⁻⁸ mol·m⁻²·s⁻¹·Pa⁻¹) is 2,500 times lower than that of water although they have similar kinetic diameters (0.265 nm for water and 0.26 nm for helium). No noticeable permeation was detected for other gas molecules with kinetic diameters larger than 0.275 nm (Ne, CO₂, Ar, O₂, N₂).

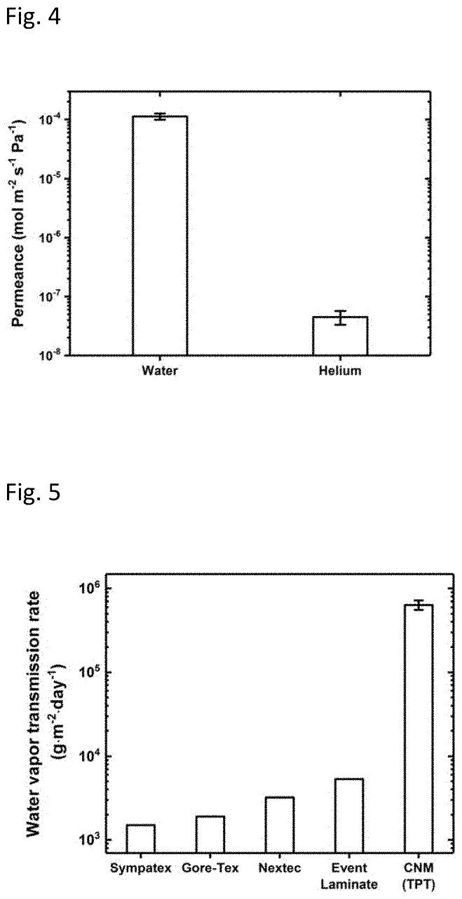

FIG. 4 shows the measured permeance for water in comparison to the one for helium. It can be seen from the figure that the measured permeances of water is higher than that of helium by more than three orders of magnitude even if the kinetic diameter of water is larger than that of helium. The method of separating the fluidic water from the impure fluids of one or more substances having a similar kinetic diameter as water, like helium, nitrogen, and oxygen and the filter for such a separation thus shows a very high selectivity. Examples of the one or more substances with a similar kinetic diameter are given in the following table:

TABLE 2
examples for substances with a similar kinetic
diameter of water. Values are from http://en.
wikipedia.org/wiki/Kinetic_diameter (downloaded
on 14 May 2018) with exception oft hose for methanol,
ethanol, n-hexane, acetonitrile (all from supporting
information to S. Van der Perre et al., Langmuir
30, 8416 (2014)), and 2-propanol (S. Wannapaiboon,
Journal of Materials Chemistry A3, 23385 (2015))

| | | | Kinetic |
|---|---|---|---|
| Molecule | | Molecular | diameter |
| Name | Formula | weight | (pm) |
| Hydrogen | H₂ | 2 | 289 |
| Helium | He | 4 | 260 |
| Methane | CH₄ | 16 | 380 |
| Ammonia | NH₃ | 17 | 260 |
| Water | H₂O | 18 | 265 |
| Neon | Ne | 20 | 275 |
| Acetylene | C₂H₂ | 26 | 330 |
| Nitrogen | N₂ | 28 | 364 |
| Carbon monoxide | CO | 28 | 376 |
| Ethylene | C₂H₄ | 28 | 390 |
| Nitric oxide | NO | 30 | 317 |
| Oxygen | O₂ | 32 | 346 |
| Methanol | CH₄O | 32 | 380 |
| Hydrogen sulfide | H2S | 34 | 360 |
| Hydrogen chloride | HCl | 36 | 320 |
| Argon | Ar | 40 | 340 |
| Acetonitrile | C₂H₃N | 41 | 340 |
| Propylene | C₃H₆ | 42 | 450 |
| Carbon dioxide | CO₂ | 44 | 330 |
| Nitrous oxide | N₂O | 44 | 330 |
| Propane | C₃H₈ | 44 | 430 |
| Ethanol | C₂H₆O | 46 | 430 |
| 2-Propanol | C₃H₈O | 60 | 470 |
| Sulfur dioxide | SO₂ | 64 | 360 |
| Chlorine | Cl₂ | 70 | 320 |
| Benzene | C₆H₆ | 78 | 585 |
| Hydrogen bromide | HBr | 81 | 350 |
| Krypton | Kr | 84 | 360 |
| n. Hexane | C₆H₁₄ | 86 | 430 |
| Xenon | Xe | 131 | 396 |
| Sulfur hexafluoride | SF₆ | 146 | 550 |
| Carbon tetrachloride | CCl₄ | 154 | 590 |
| Bromine | Br₂ | 160 | 350 |

FIG. 5 shows the water vapor transmission rate of the terphenyl based carbon nanomembrane based on the measured permeance in comparison to conventional membranes. It will be seen that the rate is orders of magnitude higher.

The carbon nanomembranes have a nanofluidic flow enhancement. The transport rate for water does not depend significantly on the thickness of the carbon nanomembrane, or on the length of the precursor molecules, see table 1. The selectivity to non-polar small molecules can be expected to increase with the thickness, or with the length of the precursor molecules as shown by the following calculation.

Assuming the transport of water and non-aqueous air molecules through the carbon nanomembrane with a thickness x in the time t with diffusion constant D can be modelled by the diffusion function for the concentration c behind the membrane (see for example the disclosure in http://demonstrations.wolfram.com/DiffusionInOneDimension/— downloaded on 14 May 2017)

c(exit)=c₀/2sqrt(πDt)exp(−x²/(4Dt))

The ratio g of the water concentration c₁ to the concentration of non-aqueous air components c₂ will be

g=c₁/c₂=c₀₁/c₀₂sqrt(D₂/D₁)exp(−x²/(4t)(1/D₁−1/D₂))

The permeability P across a membrane is proportional to the diffusion constant D (see exemplarily http://www.tiem.utk.edu/˜gross/bioed/webmodules/permeability.htm—downloaded on 14 May 2017). If D1 is expressed as

D₁=h*D₂

with the values in FIG. 3, h is about 10³ to 10⁴. Thus

g=c₀₁/c₀₂sqrt(1/h)exp(−x²/(4tD₂)(1/h−1))

Neglecting 1/h in the exponent gives

g=c₀₁/c₀₂sqrt(1/h)exp(x²/(4tD₂))

Comparing a quaterphenyl based carbon nanomembrane to the terphenyl based one, the ratio of the selectivities of the quaterphenyl based carbon nanomembrane to the terphenyl based one g_{q}/gₜ becomes

g_{q}/gₜ=exp(1/(4tD₂)(x_{q}²−xₜ²)

Assuming the thicknesses of the two membranes follow x_{q}=4/3 xₜ we get

g_{q}/gₜ=exp(xₜ²/(4tD₂)((4/3)²−1)=exp(7/9xₜ²/(4tD₂)).

Since the diffusion length for non-aqueous air components 2 sqrt (D2 t) is very small compared to the thickness xₜ of the carbon nanomembrane, this ratio is high and a significant improvement of the selectivity of the quaterphenyl membrane over the terphenyl one can be expected. A corresponding reasoning applies to a comparison of a terphenyl based membrane with a biphenyl based one. Since the mechanical stability of membrane will also increase with the thickness, a terphenyl based membrane is preferred compared to a biphenyl based one, and quaterphenyl based or those made from even longer precursor molecules like polyphenyl compounds are even more preferred.

### Example 2

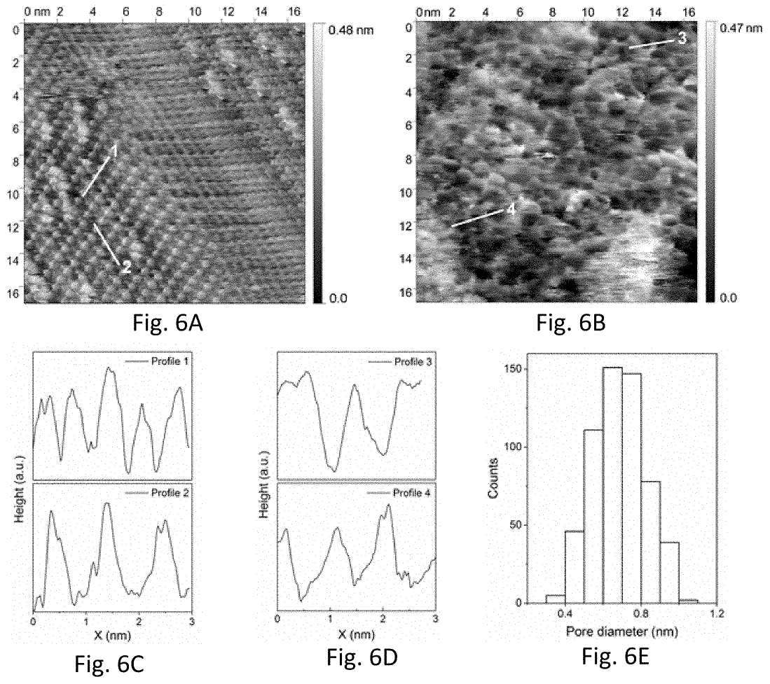

To explore the morphology of TPT SAMs and CNMs (prepared as in Example 1), scanning tunneling microscopy (STM) and atomic force microscopy (AFM) was employed. (FIGS. 6A-6E). The STM image of TPT SAM (FIG. 6A) was obtained by using a multi-chamber UHV system (Omicron) with a base pressure of 5×10⁻¹¹ mbar. The measurement was operated at room temperature.

The tunneling tip was prepared by electrochemical etching (3 mol·l-1 NaOH solution) of a tungsten wire and further processed in situ by sputtering with Ar⁺-ions (pAr=3×10⁻¹⁰ mbar, E=1 keV, t=1-2 min). The AFM images of TPT SAM and CNM (FIG. 6B) were acquired using an RHK UHV 7500 system (5×10¹¹ mbar) with R9 controller.

The measurements of TPT SAM and TPT CNM were conducted in the non-contact operation mode and the amplitude-modulated tapping operation mode respectively at 93 K using a liquid nitrogen flow cryostat. Before measurements, the TPT SAM samples were first annealed in UHV for 1 h at 323 K and later for 1 h at 333 K for removal of residual adsorbates. The TPT CNM samples were annealed in UHV at 348 K for 30 min. The AFM tips were sputtered with Ar⁺-ions at 680 eV for 90 s. For the AFM images, Tap300Al-G force sensors (˜40 N/m, ˜280 kHz, Q˜10000, Budget Sensors) were used. Analysis and post-processing (including corrections for thermal drift and polynomial background subtraction) of the STM and AFM data occurred in the open-source software package Gwyddion (34) (http://gwyddion.net/).

These pore diameters dₚₒᵣₑ were estimated manually by measuring the area of the pores (Aₚₒᵣₑ) shown in AFM images using the mask drawing tool in Gwyddion. The pore diameter was calculated by assuming that all pores are circular.

$${d}_{pore} = \sqrt{\frac{4 {A}_{pore}}{π}}$$

The topography of a TPT SAM showed that the TPT molecules were grown in different but highly oriented and densely packed monolayer domains on Au(111) surface (FIGS. 6A, 6C). X-ray photoelectron spectroscopy (XPS) measurements revealed that the TPT molecules were arranged in a densely packed 1.2-nm-thin monolayer. Surprisingly, after electron irradiation, this monolayer structure is completely reorganized; and the resulting CNM contains a dense channel network with an average channel diameter of 0.7±0.1 nm and an areal density of ˜10¹⁸ m² (FIGS. 6B, 6D, 6E).

It will be noted that the AFM measurement was conducted in the tapping-operation mode, which is essentially dominated by short-range repulsive interaction forces. See, Garcia et al., Physical Review B 60, 4961 (1999). Since the water permeation in the channel is also affected by (attractive) long-range forces, the effective pore diameter is assumed to be considerably smaller than the 0.7 nm measured in AFM.

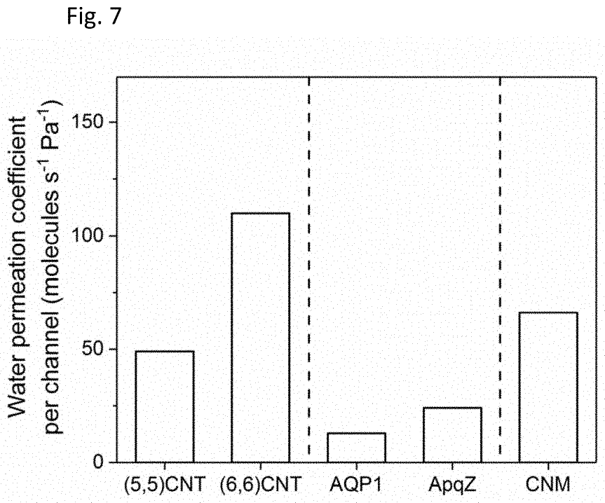

Assuming that all sub-nanometer channels in the CNMs are active in mass transport, the permeation coefficient of TPT CNM was calculated by dividing the measured permeance by the areal density of nanochannels estimated from the AFM images. The single-channel permeation coefficient is approximately 66 water molecules·s⁻¹·Pa⁻¹. This value compares well with the values obtained for carbon nanotubes and aquaporin proteins (FIG. 7). It is known that water molecules confined in sub-nanometer channels form water chains attributed to the strong and short time hydrogen-bonding character between neighboring molecules (see J. Kofinger et al., Physical Chemistry chemical Physics 13, 15403 (2011)), which allows water to rapidly rush through as a single file. This cooperative effect can well explain the unexpectedly high water permeance through CNMs.

There was no reason for the skilled person knowing the art to expect that the water transport through the pores of a nanometer thin carbon nanomembrane disclosed in this document would resemble more the transport through channels like CNT or aquaporins than the ballistic transport through pores in thin sieves.

### Example 3

The CNMs were prepared from biphenyl-based precursor molecules on aluminized polymer films according to the methods disclosed in international Patent Application No WO2017/072272. Analogue to example 1, these were transferred to a silicon nitride membrane 22 supported by a Si frame 23 where the silicon nitride membrane 22 has a regular hole 24 to form a test sample 28 and characterized accordingly for their water permeation. An average value for the water permeance of 6.5×10⁻⁵ mol m⁻² s⁻¹ Pa⁻¹ was measured, which is about half of that of the TPT- and QPT-CNMs in example 1.

### Applications

In addition to the application for the use in a radiation environment mentioned above, the carbon nanomembrane could also be used in clothing, for dehumidification of gas, as well as for dehydration of materials, such as organic materials. It would also be possible to use the carbon nanomembrane for desalination, for example from sea water.

One application could be for recovery of potable water from a humid atmosphere or from foul water. It would be possible to use the carbon nanomembrane of this document to obtain water from the enclosed atmosphere of a spacecraft. This is useful in space due to the radiation resistance of the carbon nanomembrane. In this latter case, the atmosphere would be the impure fluid 35 and the potable water would be the fluidic water 45 shown in FIG. 1.

1. A method of separating fluidic water from impure fluids, the impure fluids comprising fluidic water and one or more substances having a kinetic diameter similar to that of water molecules, comprising
applying to a first side of a carbon nanomembrane the impure fluid; and
collecting from the opposite of the carbon nanomembrane the fluidic water.

2. The method of claim 1, wherein the kinetic diameter of the one or more substances is at most 50% greater than that of the water molecules, and preferably at most 33% greater than that of the water molecules.

3. The method of claim 1, wherein the one or more substances are non-polar.

4. The method of claim 1, wherein the one or more substances are one of helium, neon, carbon dioxide, argon, oxygen, nitrogen, acetonitrile, n-hexane, ethanol, and 2-propanol.

5. The method of claim 1, wherein the carbon nanomembrane comprising laterally cross-linked aromatic compounds.

6. The method of claim 5, wherein the aromatic compounds are selected from the group consisting of polyphenyl compounds.

7. The method of claim 5, wherein the aromatic compounds are at least one of a terphenyl or quaterphenyl.

8. The method of claim 1, wherein the carbon nanomembrane has a thickness of between 0.5 nm and 100 nm.

9. The method of claim 1, wherein the carbon nanomembrane has pores with diameters in the range of 0.3 nm to 1.5 nm.

10. A filter for separating fluidic water from impure fluids, the impure fluids comprising fluidic water and one or more substances having a kinetic diameter similar to that of water molecules, wherein the filter comprises:
a first container comprising the impure fluids;
a second container for collecting the fluidic water; and
a carbon nanomembrane located between the first container and the second container and arranged in such a manner that one surface of the carbon nanomembrane is in fluidic contact with the impure fluids.

11. The filter of claim 10, wherein the kinetic diameter of the one or more substances is at most 50% greater than that of the water molecules, and preferably at most 33% greater than that of the water molecules.

12. The filter of claim 10, wherein the one or more substances are non-polar.

13. The filter of claim 10, wherein the one or more substances are one of helium, neon, carbon dioxide, argon, oxygen, nitrogen, acetonitrile, n-hexane, ethanol, and 2-propanol.

14. The filter of claim 10, wherein the carbon nanomembrane substantially consists of laterally cross-linked aromatic compounds.

15. The filter of claim 14, wherein the aromatic compounds are selected from the group consisting of polyphenyl compounds.

16. The filter of claim 14, wherein the aromatic compounds are at least one of a terphenyl or quaterphenyl.

17. The filter claim 10, wherein the carbon nanomembrane has a thickness of between 0.5 nm and 100 nm.

18. The filter claim 10, wherein the carbon nanomembrane has pores with diameters in the range of 0.3 nm to 1.5 nm.

19. The filter of claim 10, wherein the carbon nanomembrane is radiation resistant.

20. (canceled)

21. A method for the extraction of potable water from a humid atmosphere, the humid atmosphere comprising fluidic water and one or more substances having a kinetic diameter substantially similar to that of water molecules, the method comprising
applying to a first side of a carbon nanomembrane a humid atmosphere; and
collecting from the opposite of the carbon nanomembrane the potable water.

22. A method of separating fluidic water from impure fluids using a carbon nanomembrane comprising laterally cross linked terphenyl or quaterphenyl compounds, the impure fluids comprising fluidic water and one or more substances, the method comprising:
applying to a first side of a carbon nanomembrane the impure fluid; and collecting from the opposite of the carbon nanomembrane the fluidic water.

23. A filter for separating fluidic water from impure fluids, the impure fluids comprising fluidic water and one or more substances, wherein the filter comprises:
a first container comprising the impure fluids;
a second container for collecting the fluidic water; and
a carbon nanomembrane comprising laterally cross linked terphenyl or quaterphenyl compounds located between the first container and the second container and arranged in such a manner that one surface of the carbon nanomembrane is in fluidic contact with the impure fluids.
